(19) United States
(12) Patent Application Publication
(10) Pub. No.: US 2015/0156856 A1
(43) Pub. Date: Jun. 4, 2015

(54) HEAT TREATMENT APPARATUS

(71) Applicant: Hitachi High-Technologies Corporation, Tokyo (JP)

(72) Inventors: Masatoshi MIYAKE, Tokyo (JP); Kenetsu YOKOGAWA, Tokyo (JP); Takashi UEMURA, Tokyo (JP); Hiromichi KAWASAKI, Tokyo (JP)

(73) Assignee: Hitachi High-Technologies Corporation

(21) Appl. No.: 14/552,813

(22) Filed: Nov. 25, 2014

(30) Foreign Application Priority Data
Nov. 29, 2013 (JP) 2013-246886

(51) Int. Cl. H05H 1/24

(52) U.S. Cl. CPC H05H 1/24

(57) ABSTRACT

A heat treatment apparatus includes a heat treatment chamber to conduct heat treatment of a heated sample, a planar first electrode disposed in the heat treatment chamber, a planar second electrode to create plasma in a space between the first and second electrodes and to heat the heated sample, a radio-frequency power source to supply the first electrode with radio-frequency power to create the plasma, and a sample stage opposing the first electrode with the second electrode placed between the first electrode and the sample stage, to mount thereon the heated sample, wherein the first electrode is lower in thermal emissivity than the second electrode.

### BACKGROUND OF THE INVENTION

The present invention relates to a heat treatment apparatus using plasma.

As material of a substrate of a power semiconductor device, it has been recently expected to introduce new material having a wide band gap such as silicon carbide (SiC). Silicon carbide is superior in physical characteristics to silicon (Si). Specifically, silicon carbide is superior to silicon with respect to the insulation breakdown electric field, the saturation electron velocity, and the thermal conductivity. Since silicon carbide is material having high insulation breakdown electric field intensity, it is possible to reduce thickness of devices produced using silicon carbide, and high-density doping can be conducted. This makes it possible to produce a high-voltage and low-resistance device.

Due to the large band gap of the silicon carbide, it is possible to suppress thermally excited electrons, and heat radiation capability is high due to the high thermal conductivity, leading to a stable operation of the device at a high temperature. By implementing silicon carbide power semiconductor devices, it can be expected to considerably improve efficiency and performance in various electric appliances and machines for electric power to conduct power distribution and conversion, industrial power appliances, and electric appliances for family use.

Processes to produce various power devices by using a silicon carbide substrate are similar to those to produce the devices by using a silicon substrate. However, the heat treatment process of these processes considerably differs from each other. As a representative heat treatment process, there is conducted activation annealing after impurity ion sputtering to control the conductivity of the substrate. For a silicon device, the activation annealing is carried out at a temperature ranging from 800° C. to 1200° C. For a silicon carbide device, it is required to conduct the activation annealing at a temperature ranging from 1200° C. to 2000° C. due to characteristics of silicon carbide as the material. JP-A-2013-123028 (corresponding to U.S. Patent Publication No, 2013/112670A1) describes an annealing apparatus for use with silicon carbide in which a heated sample is heated by use of atmospheric plasma created using radio-frequency power.

### SUMMARY OF THE INVENTION

Due to the annealing apparatus described in JP-A-2013-123028, it is expectedly possible that when compared with the conventional resistive heating furnace, heat efficiency and heating response performance are improved and cost reduction is realized for consumable articles of the furnace. However, for the heat treatment apparatus using the atmospheric plasma, if the diameter of the substrate (heated sample) becomes larger in future, it will be required to further improve the heating temperature distribution on the substrate surface.

On the other hand, as the heating temperature becomes higher, the influence of the heating temperature distribution onto electric characteristics of the heated sample becomes smaller. Hence, the inventors discuss the improvement of heat efficiency of the heated sample. Through discussion about the plasma heat treatment apparatus which is described in JP-A-2013-123028 and in which the heated sample is heated by use of atmospheric plasma, the following problems are recognized as a result.

In the plasma heat treatment apparatus described in JP-A-2013-123028, the heated sample is heated by use of plasma created between parallel plate electrodes by radio-frequency power. In the range of temperature from 1200° C. to 2000° C. required to activate silicon carbide, heat radiation is the dominant factor of thermal loss. Hence, to increase heating efficiency, it is required to lower the heat radiation loss by surrounding the heat source with an insulating material having low thermal emissivity. However, although the plasma heat treatment apparatus of JP-A-2013-123028 is configured in insulating structure in the viewpoint of confinement of heat in the system including the heated sample, the flow of heat to heat the heated sample has not been fully taken into consideration in the structure.

In the plasma heat treatment apparatus described in JP-A-2013-123028, the parallel plate electrodes opposing each other are configured by using one and the same material. Hence, the electrodes are substantially equal in the thermal emissivity to each other and are substantially equal in heat radiation to each other. That is, heat radiation which is almost equivalent to the heat radiation in the direction to heat the heated sample takes place in the direction opposite to the direction in which the heat radiation takes place toward the heated sample mounting side. This is not favorable from the viewpoint of heating efficiency.

It is therefore an object of the present invention to provide a heat treatment apparatus wherein in the high-temperature zone in which the heat radiation is dominant, the heat loss can be lowered in almost the entire system and the heating efficiency of the heated sample can be increased by controlling the flow of heat.

According to the present invention, there is provided a heat treatment apparatus, including a heat treatment chamber to conduct heat treatment of a heated sample, a planar first electrode disposed in the heat treatment chamber, a planar second electrode to create plasma in a space between the first electrode and the second electrode and to heat the heated sample disposed in the heat treatment chamber, a radio-frequency power source to supply the first electrode with radio-frequency power to create the plasma, and a sample stage opposing the first electrode with the second electrode placed between the first electrode and the sample stage, to mount thereon the heated sample, wherein the first electrode is lower in thermal emissivity than the second electrode.

Also, according to the present invention, there is provided a heat treatment apparatus, including a heat treatment chamber to conduct heat treatment of a heated sample, a planar first electrode disposed in the heat treatment chamber, a planar second electrode to create plasma in a space between the first electrode and the second electrode and to heat the heated sample disposed in the heat treatment chamber, a radio-frequency power source to supply the first electrode with radio-frequency power to create the plasma, and a sample stage opposing the first electrode with the second electrode placed between the first electrode and the sample stage, to mount thereon the heated sample, wherein the first electrode is higher in thermal emissivity than the second electrode.

According to the present invention, it is possible to increase the heating efficiency of the heated sample in the high-temperature zone.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross-sectional diagram showing a basic configuration of a heat treatment apparatus according to an embodiment of the present invention;

FIG. 2 is a cross-sectional diagram taken along line A-A′ of the heat treatment apparatus of FIG. 1 viewed from the side of a second electrode;

FIG. 3 is a graph showing a calculation result of a temperature distribution of a heated sample; and

FIG. 4 is a schematic diagram showing exchange of heat radiated between parallel plate electrodes which are different in thermal emissivity from each other.

### DESCRIPTION OF THE EMBODIMENTS

In the exchange of heat at a temperature ranging from 1200° C. to 2000° C. required to activate silicon carbide, the heat radiation is dominant when compared with heat conduction and heat transmission. Conventionally, emphasis has been placed on how to suppress the loss due to heat radiation. However, the inherent target is how to efficiently heat the heated sample. For this purpose, it is important in the designing of the heat treatment apparatus to take the flow of heat due to heat radiation into consideration. It is desirable that heat radiation is positively conducted in the direction toward the heated sample while heat radiation is suppressed in other than the direction toward the heated sample.

The present invention has been made based on the findings described above. In the configuration according to the present invention, by setting the thermal emissivity of a first electrode to be lower than that of a second electrode which is in the vicinity of the heated sample and which opposes the first electrode, the flow of heat to the first electrode side on which the heated sample does not exist is suppressed. This increases heat radiation onto the heated sample side to thereby efficiently heat the heated sample. Due to the configuration of the present invention, the heating efficiency of the heated sample can be increased. Next, description will be given in detail of an embodiment of the present invention.

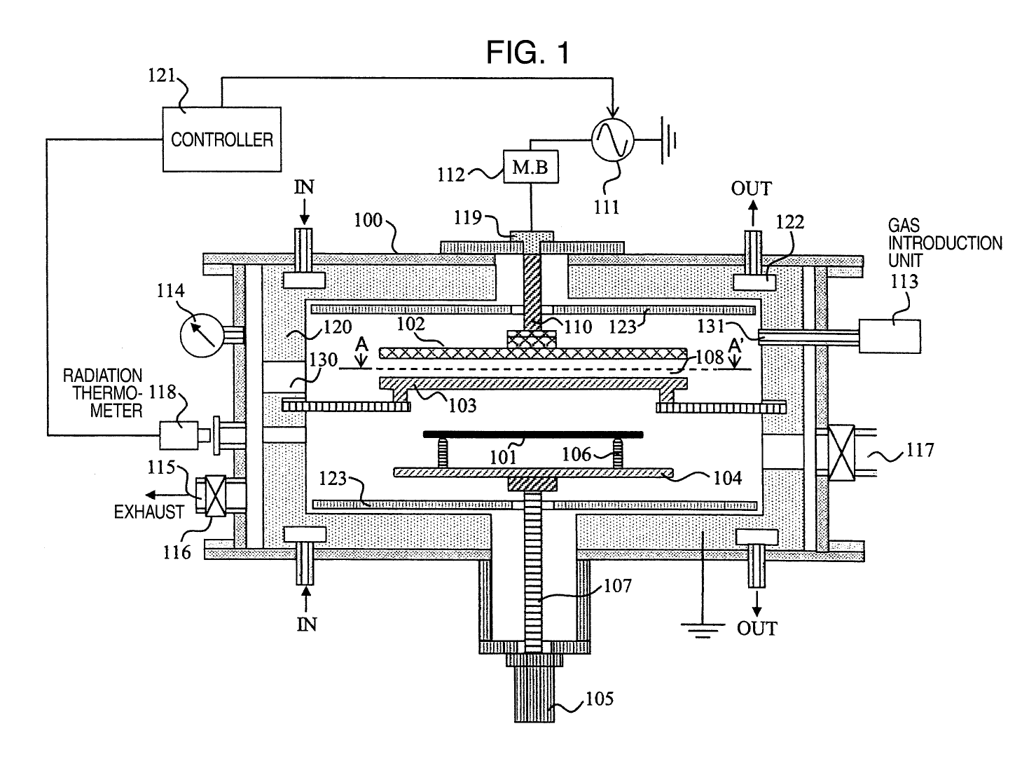

Referring now to FIGS. 1 to 3, description will be given of a heat treatment apparatus according to the present invention. In the drawings, the same constituent components are assigned with the same reference numeral. FIG. 1 shows a basic configuration of the heat treatment apparatus according to the present embodiment in a cross-sectional diagram. The heat treatment apparatus includes a heat treatment chamber 100 in which a heated sample 101 as the processing target is indirectly heated by a second electrode 103 heated by use of plasma generated in a space between a first electrode 102 and a second electrode 103.

The heat treatment chamber 100 includes a first electrode 102, a second electrode 103 which is a heating plate disposed to oppose the first electrode 102, a sample stage 104 including support pins 106 to support the heated sample 101, a reflection mirror 120 to reflect radiated heat, a radio-frequency power source 111 to supply the first electrode 103 with radio-frequency power to generate plasma, a gas introduction unit 113 to supply the heat treatment chamber 100 with gas, and a vacuum valve 116 to adjust pressure in the heat treatment chamber 100. Reference numeral 117 indicates a heated sample transporting hole to transport a heated sample therethrough. It is also possible to supply the second electrode 103 with radio-frequency power to generate plasma.

The heated sample 101 is supported on the support pins 106 of the sample stage 104 to be arranged below and in the vicinity of the second electrode 103. The second electrode 103 is held by the reflection mirror 120 and is not in contact with the heated sample 101 and the sample stage 104. In the present embodiment, a 4-inch (φ 100 mm) silicon carbide substrate is employed as the heated sample 101. The first electrode 102 and the sample stage 104 are each 120 mm in diameter and 5 mm in thickness.

The first electrode 102 is produced using wolfram. The second electrode 103 includes a graphite substrate in which silicon carbide is deposited on the surface of the graphite substrate by Chemical Vapor Deposition (CVD). In the infrared zone and the visible light zone associated with wavelengths for which the heat radiation is dominant at a temperature ranging from 1200° C. to 2000° C., the thermal emissivity is about 0.3 for wolfram and about 0.8 for silicon carbide.

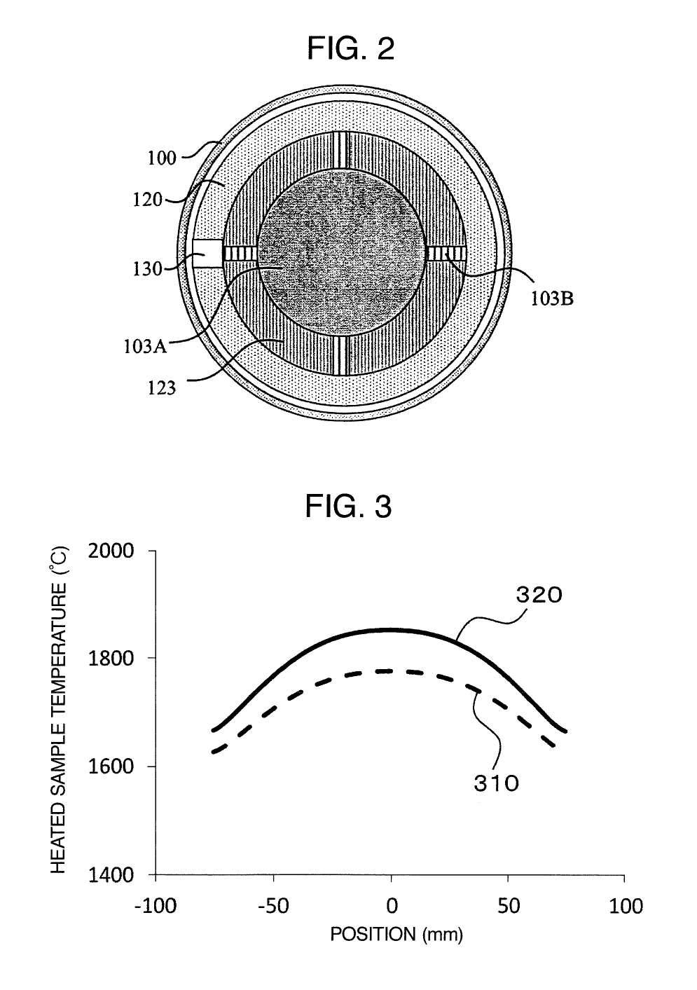

Referring now to FIG. 2, description will be given of the configuration of the second electrode 103. FIG. 2 shows the side of the second electrode 103 of the heat treatment apparatus in a cross-sectional view taken along line A-A′ of FIG. 1. The second electrode 103 includes a disk-shaped member 103A and four beams 103B arranged substantially equally separated from each other to connect the disk-shaped member 103A to the reflection mirror 120. The disk-shaped member 103A as the main constituent component of the second electrode 103 has a thickness of about two millimeters. The number, the cross-sectional area, and the thickness of the beams 103B will be determined in consideration of strength of the second electrode 103 and quantity of heat radiated from the second electrode 103 to the reflection mirror 120. The second electrode 103 is disposed over the heated sample 101. Since the side surfaces of the heated sample 101 are not covered with the second electrode 103 in this configuration, the surface area of the second electrode 103 can be reduced. Hence, it is possible to reduce quantity of heat radiated from the second electrode 103. To cover the side surfaces of the heated sample 101, it is also possible to dispose a member having a cylindrical contour on the lower side of the second electrode 103 (on the side thereof opposite to the side of the surface opposing the first electrode 102). In this situation, although the quantity of heat radiated from the second electrode 103 including the cylindrical member increases, the quantity of heat radiated from the heated sample 101 can be reduced.

The gap between the second electrode 103 and the first electrode 102 is 0.8 mm. The heated sample 101 has a thickness ranging from about 0.5 mm to about 0.8 mm. In the first and second electrodes 102 and 103, the circumferential corners on the opposing sides respectively thereof are tapered or rounded. The circumferential corners are formed in this contour to suppress localization of plasma due to concentration of the electric field on the respective circumferential corners. The sample stage 104 is connected via a shaft 107 to an elevating mechanism 105. By operating the elevating mechanism 105, it is possible to transfer the heated sample 101 and to drive the heated sample 101 to approach the second electrode 103. The operation will be described later in detail. The shaft 107 is produced using alumina.

The first electrode 102 is supplied with radio-frequency power via an upper feeder line 110 from the radio-frequency power source 111. In the present embodiment, the radio-frequency power source 111 supplies power having a frequency of 13.56 MHz. The second electrode 103 is conductively connected via the beams 103B to the reflection mirror 120. Further, the second electrode 103 is grounded via the reflection mirror 120. The upper feeder line 110 is produced using graphite which is also the material of the second electrode 103. Between the radio-frequency power source 111 and the first electrode 102, a matching circuit 112 is arranged. In this regard, the matching circuit 112 is indicated as Matching Box (MB) in FIG. 1. In the configuration, the radio-frequency power is efficiently supplied from the radio-frequency power source 111 to plasma formed between the first and second electrodes 102 and 103. In the present embodiment, the radio-frequency power source 111 is connected via the matching circuit 112 to the first electrodes 102. However, the radio-frequency power source 111 may be connected via the matching circuit 112 also to the second electrode 103 or only thereto.

In the configuration of the heat treatment chamber 100, the first and second electrodes 102 and 103 and the sample stage 104 are surrounded with the reflection mirror 120. The reflection mirror 120 includes a metallic substrate such that an inner wall surface of the metallic substrate is optically polished, and then gold is plated or evaporated onto the polished surface. In the metallic substrate of the reflection mirror 120, a coolant flow path 122 is formed. By flowing cooling water through the coolant flow path 122, the temperature of the reflection mirror 120 is kept at a predetermined value. On the reflection mirror 120, the radiant heat radiated from at least one of the first electrode 102, the second electrode 103, and the sample stage 104 is reflected. Hence, the radiant heat is suppressed and the thermal efficiency becomes higher. However, when the heat treatment temperature is intermediate or low temperature, it is not necessarily required to employ the reflection mirror 120.

Between the first electrode 102 and the reflection mirror 120 and between the sample stage 104 and the reflection mirror 120, a protective quartz plate 123 is arranged. The protective quartz plate 123 serves a function to keep the surface of the reflection mirror 120 clean. Specifically, the protective quartz plate 123 prevents matters (such as sublimed graphite) emitted from the first and second electrodes 102 and 103 and the sample stage 104, which become at a high temperature of 1200° C. or more during the heat treatment, from sticking onto the surface of the reflection mirror 120. The protective quartz plate 123 also serves a function to prevent contamination caused by a fact that contamination from the reflection mirror 120 is mixed into the heated sample 101.

The heat treatment chamber 100 in which the first and second electrodes 102 and 103 are arranged is configured such that gas with up to ten atmospheres (atm) can be introduced into the heat treatment chamber 100 by use of a gas introduction unit 113 and a gas introduction nozzle 131. The pressure of gas thus introduced is monitored by a pressure sensing unit 114. It is possible to exhaust gas from the heat treatment chamber 100 by a vacuum pump connected to an exhaust hole 115 and a vacuum valve 116. It is favorable that a tip end of the gas introduction nozzle 131 is arranged at a position with height corresponding to a position between the first and second electrodes 102 and 103.

The tip end of the gas introduction nozzle 131 is formed in the tapered contour to vigorously blow gas into the space between the first and second electrodes 102 and 103. The gas introduction nozzle 131 is arranged at a variable position. To prevent electric discharge between the first electrode 102 and the gas introduction nozzle 131, it is desirable to employ insulator for the gas introduction nozzle 131. In the present embodiment, alumina is used for the gas introduction nozzle 131. At a position with height corresponding to a position between the first and second electrodes 102 and 103, an internal exhaust hole 130 is disposed. By lowering conductance of the space ranging from the upper and lower electrodes to the internal exhaust hole 130, it is possible to efficiently exhaust gas from the space between the electrodes 102 and 103.

As a result, soot emitted from each electrode is not kept stayed in the heat treatment chamber 100 and is quickly discharged therefrom. Since the gas introduction nozzle 131 is disposed above the beams 103B of the second electrode 103, it is possible to prevent the gas introduced into the heat treatment chamber 100 from flowing into the space below the second electrode 103. Hence, the gas can be efficiently fed into the space between the electrodes 102 and 103. Since the internal exhaust hole 130 is disposed at a position to oppose the gas introduction nozzle 131, it is possible to easily replace gas in the space between the first and second electrodes 102 and 103.

In the present embodiment, gas of helium (He) is introduced into the heat treatment chamber 100. When the gas pressure is stabilized in the heat treatment chamber 100, radio-frequency power is supplied from the radio-frequency power source 111 via the matching circuit 112 and a power introduction terminal 119 to the first electrode 102 to generate plasma in a gap 108, to thereby heat the first and second electrodes 102 and 103. Energy of the radio-frequency power is absorbed by electrons in the plasma, and then the electrons collide with the processing gas to heat atoms and molecules of the processing gas.

Ions generated through ionization are accelerated by the potential difference appearing in the sheath on the surfaces of the first and second electrodes 102 and 103 brought into contact with the plasma and are then incident to the first and second electrodes 102 and 103 while colliding with the processing gas. Through the collision process, the temperature of the gas in the space between the first and second electrodes 102 and 103 and the temperature of the surfaces of the first and second electrodes 102 and 103 are increased. During the heating process, by suspending the introduction of helium gas into the heat treatment chamber 100 or by reducing the quantity of introduced gas to substantially zero, it is possible to heat the electrodes to a higher temperature.

Particularly, in the heat treatment process under the pressure near the atmospheric pressure as in the present embodiment, ions frequently collide with the processing gas when ions pass through the sheath. Hence, it is possible to efficiently heat the processing gas in the space between the first and second electrodes 102 and 103. As a result, the temperature of these electrodes becomes higher. This increases loss due to heat radiation and the like. With a lapse of time, heat imparted to these electrodes balances with heat lost from the electrodes, to substantially saturate the temperature of the electrodes.

FIG. 3 graphically shows a calculation result of a temperature distribution of the heated sample on assumption that the supplied radio-frequency power is 13 kW and the facing surfaces of the first and second electrodes 102 and 103 are substantially uniformly heated. According to a curve 310 representing the temperature distribution in a situation in which the first and second electrodes 102 and 103 have substantially an equal thermal emissivity of 0.8 (in the configuration of the electrodes described in JP-A-2013-123028), the temperature of the heated sample becomes higher toward the center thereof. The temperature of the center of the heated sample is 1777° C. and that of the outer circumference thereof is 1628° C.

In contrast, according to a curve 320 representing the temperature distribution in a situation in which the thermal emissivity of the first electrode 102 is reduced (similar to the configuration of the present invention), the temperature of the center of the heated sample is 1853° C. and that of the outer circumference thereof is 1666° C. In this way, when the thermal emissivity of the first electrode 102 is lower than that of the second electrode 103, the ultimate temperature of the heated sample becomes higher.

Next, description will be given of the mechanism of the increase in the heat efficiency. In the heat transfer in a high-temperature zone of 1200° C. or more, since the heat radiation is dominant, influences of heat transmission and heat conduction are neglected in this situation. Further, it is assumed that heat radiated through the heat radiation does not pass through the electrodes. Intensity E of heat radiation from a heated object is represented by expression (1) according to the Stephan-Boltzmann's law and is determined by the thermal emissivity and the temperature of the material of the object.

E=σεT⁴[W/m²] (1)

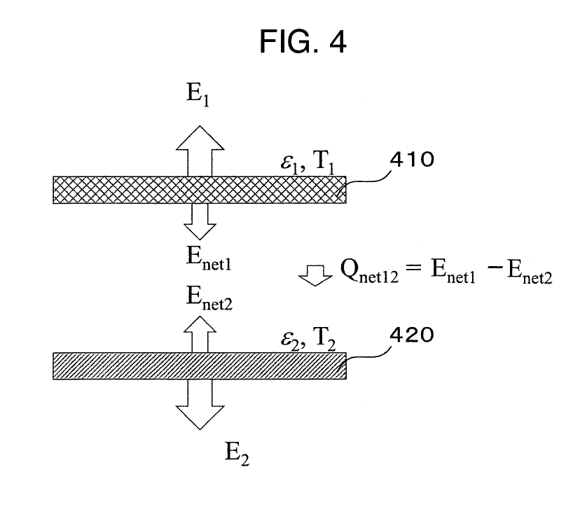

In expression (1), σ is the Stephan-Boltzmann's coefficient, ε is the thermal emissivity of the material, and T is the temperature of the material. Assume that the heat radiation takes place between the parallel plate electrodes which are different in the thermal emissivity from each other as shown in FIG. 4.

When the thermal emissivity of the upper electrode 410 is ε₁ and the temperature thereof is T₁, the heat radiation E₁ per unitary area from the upper electrode 410 is expressed as below.

E₁=σε₁T₁⁴[W/m²] (2)

Similarly, when the thermal emissivity of the lower electrode 420 is ε₂ and the temperature thereof is T₂, the heat radiation E₂ per unitary area from the lower electrode 420 is expressed as below. That is, heat is dissipated through heat radiation from each electrode.

E₂=σε₂T₂⁴[W/m²] (3)

However, when another electrode exists near an electrode surface under consideration for the heat radiation, for example, when there exists the lower electrode 420 opposing the upper electrode 410, the heat radiation E₁ from the upper electrode 410 facing the lower electrode 420 is reflected on the lower electrode 420 with a reflective factor of (1−ε₂) and is then again incident to the upper electrode 410. In this situation, part of heat radiation expressed as (1−ε₂) ε₁E₁ is absorbed by the upper electrode 410. Further, part of heat radiation expressed as (1−ε₂) (1−ε₁) E₁ is reflected on the upper electrode 410 and is again incident to the lower electrode 420. In this fashion, the heat radiation from a surface opposing a nearby electrode attenuates by repeatedly conducting reflection between the surface and the opposing electrode. For the heat radiation E₁, the net heat radiation Enet₁ from the upper electrode 410 to the lower electrode 420 is expressed as below.

$${E}_{net 1} = \frac{{ɛ}_{2} {E}_{1}}{1 - ( 1 - {ɛ}_{1} ) ( 1 - {ɛ}_{2} )} = \frac{{σɛ}_{1} {ɛ}_{2} {T}_{1}^{4}}{1 - ( 1 - {ɛ}_{1} ) ( 1 - {ɛ}_{2} )} [ W \text{/} {m}^{2} ] \qquad ( 4 )$$

Similarly, for the heat radiation E₂, the net heat radiation Enet₂ from the lower electrode 420 to the upper electrode 410 is expressed as below.

$${E}_{net 2} = \frac{{ɛ}_{1} {E}_{2}}{1 - ( 1 - {ɛ}_{1} ) ( 1 - {ɛ}_{2} )} = \frac{{σɛ}_{1} {ɛ}_{2} {T}_{2}^{4}}{1 - ( 1 - {ɛ}_{1} ) ( 1 - {ɛ}_{2} )} [ W \text{/} {m}^{2} ] \qquad ( 5 )$$

Therefore, the heat transfer 0 from the upper electrode 410 to the lower electrode 420 is derived from expression (6) as below.

$${Q}_{net 12} = {E}_{net 1} - {E}_{net 2} = \frac{{σɛ}_{1} {ɛ}_{2} ( {T}_{1}^{4} - {T}_{2}^{4} )}{1 - ( 1 - {ɛ}_{1} ) ( 1 - {ɛ}_{2} )} [ W \text{/} {m}^{2} ] \qquad ( 6 )$$

Assume that substantially an equal quantity of heat is imparted to each of the upper electrode 410 and the lower electrode 420. As in the configuration of the electrodes described in JP-A-2013-123028, when the thermal emissivity ε₁ of the upper electrode is substantially equal to the thermal emissivity ε₂ of the lower electrode, substantially equal heat radiation is performed from each electrode. Hence, the electrodes are substantially equal in temperature to each other. As a result, no heat transfer Qₙₑₜ₁₂ takes place from the upper electrode 410 to the lower electrode 420.

On the other hand, as in the present invention, when the thermal emissivity ε₁ of the upper electrode 410 is lower than the thermal emissivity ε₂ of the lower electrode 420, the heat radiation E₁ from the upper electrode 410 is suppressed. That is, since the heat loss in the upper electrode 410 is lowered, the temperature T₁ of the upper electrode 410 is higher than the temperature T₂ of the lower electrode 420. Hence, a positive quantity of heat transfer Qₙₑₜ₁₂ takes place from the upper electrode 410 to the lower electrode 420. That is, heat flows through the heat radiation from the upper electrode 410 to the lower electrode 420.

As in the plasma heat treatment apparatus shown in FIG. 1, when the heated sample exists below the lower electrode 420, the flow rate of heat from the upper electrode 410 to the lower electrode 420 becomes higher. Hence, when compared with the plasma heat treatment apparatus described in JP-A-2013-123028, the heating efficiency is increased and the ultimate temperature of the heated sample becomes higher.

During the heat treatment of the heated sample, the temperature of the second electrode 103 or the sample stage 104 is measured by a radiation thermometer 118. To set the temperature of the second electrode 103 or the sample stage 104 to a predetermined value, the radio-frequency power from the radio-frequency power source 111 is controlled by a controller 121 based on the measured value from the radiation thermometer 118. It is hence possible to control the temperature of the heated sample 101 with high precision. In the present embodiment, the maximum radio-frequency power to be supplied from the radio-frequency power source 111 is 20 kW.

In the present embodiment, although the gap 108 between the first electrode 102 and the second electrode 103 is 0.8 mm, the similar advantage is obtainable even when the gap 108 ranges from 0.1 mm to 2 mm. When the gap 108 is less than 0.1 mm, electric discharge is possible. However, to keep the parallel state between the first electrode 102 and the second electrode 103, a function having high precision is required. Also, a change in quality (roughness and the like) of the surfaces of the first electrode and second electrodes 102 and 103 undesirably affects the state of plasma. On the other hand, when the gap 108 exceeds two millimeters, there undesirably take place problems of reduction in ignition quality of plasma and increase in the heat radiation loss in the gap.

In the present embodiment, the pressure in the heat treatment chamber is 0.1 atmosphere to produce plasma. However, the similar operation is possible under 10 atmospheres or less. Particularly, it is favorable to employ the gas pressure equal to or more than 0.01 atmosphere and equal to or less than 0.1 atmosphere. Under 0.001 atmosphere or less, the frequency of collision of ions in the sheath is lowered, and ions having high energy are incident to the electrodes. It is hence feared that the surfaces of the electrodes are sputtered as a result. As assumed in the present embodiment, when the gap 103 between the first and second electrodes 102 and 103 ranges from 0.1 mm to 2 mm, the discharge maintaining voltage undesirably goes up when the gas pressure is 0.01 atmosphere or less according to the Paschen's law.

On the other hand, when the pressure is 10 atmospheres or more, the risk of occurrence of abnormal discharge undesirably increases (in unstable plasma and/or plasma generated in other than the gap between the first electrode and second electrodes 102 and 103). In the present embodiment, the gas pressure is controlled by changing the gas flow rate. However, even when the gas pressure is adjusted by changing the gas exhaust rate, the similar advantage is obtained. The gas pressure may naturally be regulated by simultaneously changing the gas flow rate and the gas exhaust rate.

In the present embodiment, helium gas is employed as the processing gas to generate plasma. However, it is naturally possible to obtain the similar advantage by employing gas in which inert gas such as argon (Ar) gas, xenon (Xe) gas, krypton (Kr) gas or the like is used as the main constituent element. The helium gas used in the present embodiment is superior in plasma ignition and stableness under a pressure near the atmospheric pressure.

However, the helium gas is high in the thermal conductivity and is relatively large in the thermal loss due to heat conduction via the gas atmosphere. On the other hand, the gas with heavy mass such as argon, xenon, or krypton gas is low in the thermal conductivity and is hence more favorable in the thermal efficiency than the helium gas.

In the present embodiment, wolfram is used as material of the first electrode 102. However, any member having a high melting point and low thermal emissivity may be employed. The similar advantage is obtainable by using, for example, wolfram carbide (WC), molybdenum carbide (MoC), tantalum (Ta), molybdenum, or a member produced by coating a graphite substrate with tantalum carbide (TaC).

On the other hand, the side of the second electrode 103 opposite to the surface to be brought into contact with plasma is formed using graphite which is coated with silicon carbide by CVD. However, the similar advantage is obtained by use of graphite in the form of a chemical element, a member produced by coating graphite with pyrolyzed carbon, a member produced by vitrifying the surface of graphite, or silicon carbide (sinter, polycrystal, or single crystal). When the first electrode 102 is prepared by coating a graphite substrate with tantalum carbide, it is naturally desirable that the coating of the first electrode 102, the graphite as the substrate of the second electrode 103, and the coating of the second electrode 103 are high in purity to prevent contamination onto the heated sample 101.

In the present embodiment, a 13.56 MHz radio-frequency power source is adopted as the radio-frequency power source 111 to generate plasma for the following reasons. The frequency of 13.56 MHz is an industrial frequency and is available at low cost. Moreover, since the electromagnetic wave leakage standard is low, the apparatus cost can be reduced. However, in principle, the heat treatment is naturally possible based on the similar principle by use of other frequencies.

Particularly, it is favorable to use a frequency in a range from 1 MHz to 100 MHz. For the frequency less than one megahertz, the radio-frequency voltage becomes higher when the radio-frequency power required for the heat treatment is supplied. This may cause abnormal discharge (in unstable plasma and/or in other than the gap between the first and second electrodes 102 and 103), which makes it difficult to create stable plasma. For the frequency exceeding 100 MHz, impedance of the gap 108 between first and second electrodes 102 and 103 is undesirably lowered and it is difficult to obtain the voltage required to create plasma.

In the heat treatment apparatus of the present embodiment according to the present invention, the first electrode opposing the second electrode disposed in the vicinity of the heated sample is lower in the thermal emissivity than the second electrode. However, when the thermal emissivity is low, the reflection of heat increases. Hence, the heat treatment apparatus according to the present invention can also be regarded as a heat treatment apparatus including a first electrode which opposes a second electrode disposed in the vicinity of the heated sample and which is higher in the reflection of heat than the second electrode.

As above, according to the present embodiment, when a heated sample having a large diameter is heated by use of plasma, it is possible in the high-temperature zone in which the heat radiation is dominant, to lower the thermal loss in the overall system and to increase the heating efficiency of the heated sample by controlling the flow of heat. Incidentally, the present invention is not restricted by the embodiment described above and includes various variations. For example, the embodiment has been described in detail for easy understanding of the present invention, and it is not necessarily required to include all constituent components described above. Also, for a part of the configuration of the embodiment, it is possible to conduct addition, deletion, or replacement using another configuration component.

1. A heat treatment apparatus, comprising:
a heat treatment chamber configured to conduct heat treatment of a heated sample;
a planar first electrode disposed in the heat treatment chamber;
a planar second electrode configured to create plasma in a space between the first electrode and the second electrode and to heat the heated sample disposed in the heat treatment chamber;
a radio-frequency power source configured to supply the first electrode with radio-frequency power to create the plasma; and
a sample stage opposing the first electrode with the second electrode placed between the first electrode and the sample stage, to mount thereon the heated sample, wherein
the first electrode is lower in thermal emissivity than the second electrode.

2. A heat treatment apparatus according to claim 1, wherein
the first electrode includes wolfram, wolfram carbide, molybdenum carbide, tantalum, or molybdenum; and
the second electrode includes graphite.

3. A heat treatment apparatus according to claim 1, wherein
the first electrode includes wolfram; and
the second electrode includes graphite or graphite with silicon carbide (SiC) deposited on a surface thereof.

4. A heat treatment apparatus according to claim 3, wherein the second electrode comprises:
a disk-shaped member; and
beams disposed on an outer circumference of the disk-shaped member and p1 the second electrode is fixedly attached in the heat treatment chamber.

5. A heat treatment apparatus, comprising:
a heat treatment chamber configured to conduct heat treatment of a heated sample;
a planar first electrode disposed in the heat treatment chamber;
a planar second electrode configured to create plasma in a space between the first electrode and the second electrode and to heat the heated sample disposed in the heat treatment chamber;
a radio-frequency power source configured to supply the first electrode with radio-frequency power to create the plasma; and
a sample stage opposing the first electrode with the second electrode placed between the first electrode and the sample stage, to mount thereon the heated sample, wherein
the first electrode is higher in thermal emissivity than the second electrode.

6. A heat treatment apparatus according to claim 5, wherein the first electrode includes wolfram, wolfram carbide, molybdenum carbide, tantalum, or molybdenum; and
the second electrode includes graphite.

7. A heat treatment apparatus according to claim 5, wherein the first electrode includes wolfram; and
the second electrode includes graphite or graphite with silicon carbide (SiC) deposited on a surface thereof.

8. A heat treatment apparatus according to claim 7, wherein the second electrode comprises:
a disk-shaped member; and
beams disposed on an outer circumference of the disk-shaped member and
the second electrode is fixedly attached in the heat treatment chamber.
